(19) United States
(12) Patent Application Publication
(10) Pub. No.: US 2019/0182926 A1
(43) Pub. Date: Jun. 13, 2019

(54) LIGHTING DEVICE

(71) Applicant: SIGNIFY HOLDING B.V., EINDHOVEN (NL)

(72) Inventors: Dirk Valentinus René ENGELEN, EINDHOVEN (NL); Bartel Marinus VAN DE SLUIS, EINDHOVEN (NL)

(21) Appl. No.: 16/322,985

(22) PCT Filed: Jul. 13, 2017
(86) PCT No.: PCT/EP2017/067700

§ 371 Date: Feb. 4, 2019

(30) Foreign Application Priority Data
Aug. 4, 2016 (EP) 16182755.5

(51) Int. Cl. H05B 37/02; H05B 33/08; G06F 3/16; H04R 1/40

(52) U.S. Cl. CPC H05B 37/0209; H04R 1/403; G06F 3/165; H05B 33/0845

(57) ABSTRACT

A lighting device comprising: a plurality of light emitting devices arranged in a two-dimensional array; a plurality of audio emitting devices co-located with the light emitting devices; and an optically translucent surface located forward of both the light emitting devices and the audio emitting devices such that the devices are not directly visible through the surface, wherein the surface is acoustically transparent such that sounds emitted from the audio emitting devices are audible through the surface; wherein the light emitting devices are controllable to render light effects at different locations on the surface, and the audio emitting devices are controllable to emit sounds perceived to originate from matching locations.

### TECHNICAL FIELD

The present invention is directed to a lighting device comprising a plurality of light emitting devices arranged in a two-dimensional array behind a translucent surface that prevents them from being directly visible and on which they render light effects by projection.

### BACKGROUND

Luminous panels are a form of lighting device (luminaire) comprising a plurality of light emitting devices such as LEDs arranged in a two-dimensional array, placed behind (from an observer's perspective) an optically translucent surface which acts to “diffuse”, i.e. optically scatter, the light emitted from each individual LED. These panels allow for rendering of complex lighting effects (for example, rendering low resolution dynamic content) within a space and provide added value in the creation of light atmospheres and the perception of public environments whilst simultaneously illuminating the space.

The scattering is such that the light emitting devices are hidden, i.e. not directly visible through the surface. That is, their individual structure cannot be discerned by an observer looking at the surface. This provides an immersive experience, as the user sees only the light effects on the surface not the devices behind the surface that are rendering them.

FIG. 4A shows a photograph of one such luminous panel, in which the optical effect of the translucent surface 208 is readily visible. Light effects 402 are projected onto the surface 208 from behind, by a two dimensional array of LEDs behind the surface that are not directly visible through it.

An example of a luminous panel is described at http://www.gloweindhoven.nL/en/glow-projects/glow-next/natural-elements which shows an installation in which natural elements like fire and water are generated by the luminous panel in an interactive manner.

The light emitting devices (such as LEDs) in the luminous panel are arranged to collectively emit not just any light but specifically illumination, i.e. light of a scale and intensity suitable for contributing to the illuminating of an environment occupied by one or more humans (so that the human occupants can see within the physical space as a consequence). In this context, the luminous panel is referred to as a “luminaire”, being suitable for providing illumination.

U.S. Pat. No. 8,042,961 B2 discloses a device that is a lamp on the one hand, and also a speaker on the other, comprising a light-emitting element, a surface that acts as a sound-emitting element, and a base socket that can fit to an ordinary household lamp socket. The surface can be translucent and act as a lamp cover at the same time. There is also an electronic assembly in the lamp that controls both the light-emitting and sound-emitting elements, as well as communicates with an external host or other devices.

### SUMMARY

The present invention relates to a novel luminous panel, in which audio emitting devices, such as loudspeakers, are integrated along with the light emitting devices, such that the loudspeakers are also hidden behind the surface. The audio emitting devices are arranged such that audio effects (i.e. different and individually distinct sounds) can be emitted such that they are perceived to originate from desired locations on the surface.

Hence according to a first aspect disclosed herein, there is provided a lighting device comprising: a plurality of light emitting devices arranged in a two-dimensional array; a plurality of audio emitting devices co-located with the light emitting devices; and an optically translucent surface located forward of both the light emitting devices and the audio emitting devices such that the devices are not directly visible through the surface, wherein the surface is acoustically transparent such that sounds emitted from the audio emitting devices are audible through the surface; wherein the light emitting devices are controllable to render light effects at different locations on the surface, and the audio emitting devices are controllable to emit sounds perceived to originate from matching locations.

The light emitting devices and the audio emitting devices are located at predefined locations relative to the surface. Since there is a relation between the locations of the light emitting devices and the audio emitting devices, they can be controlled such that the sounds are perceived to originate from locations matching the light effects.

“Matching locations” means the same location or sufficiently nearby (e.g. behind the surface and the light effect) such that a user perceives the light effects themselves to be creating the sound.

Not only the light emitting devices but also the audio emitting devices are hidden by the translucent surface, therefore the user only sees the light effects, and the sounds are perceived to originate from the light effects themselves. This provides an enhanced immersive experience, but is not impacted by the presence of any visible loudspeakers.

A pair of stereo audio emitting devices behind the surface is sufficient for emitting sounds perceived from different locations, but only within a relatively narrow range of observation angles.

Particularly as luminous panels can be realized in large sizes, whereby the local light effects only cover part of the large surface individually, it can be desirable to co-locate rendered sound with the local light effects, for example. Note: a sound/audio effect being “collocated” with a light effect means the sound/audio effect is emitted such that it is perceived to originate from a location of the lighting effect.

In embodiments, the plurality of audio emitting devices is at least three audio devices.

In embodiments, the at least three audio emitting devices are arranged in a one-dimensional array.

In embodiments, the plurality of audio emitting devices is at least four audio emitting devices arranged in a two-dimensional array.

Preferably, the audio devices are arranged for emitting sounds from those locations using Wave Field Synthesis. As explained below, this allows the perceived matching of the audio and light effects to be perceived over a greater range of observation angles relative to the surface.

In embodiments, the plurality of light emitting devices is a plurality of light emitting diodes.

In embodiments, the optically translucent surface is a curved optically translucent surface.

According to a second aspect disclosed herein, there is provided a controller for controlling the lighting device according to the first aspect or any embodiments disclosed herein, the controller comprising: a location determining module configured to determine at least one location on the surface of the lighting device; a light controller configured to control the light emitting devices to render a light effect at the determined location on the surface; and an audio controller configured to control the audio emitting devices to emit a sound perceived to originate from the determined location whilst the light effect is being rendered, such that the sound is perceived to originate from the light effect.

In embodiments, the controller further comprises a sensor input configured to connect to at least one sensor, wherein the location on the surface is determined based on a location of at least one user detected by the at least one sensor.

In embodiments, the location determining module is configured to change the location on the surface such that the sound is perceived to originate from a moving light effect.

In embodiments, at least one characteristic of the light effect and/or the sound is varied based on a detected speed of the at least one user.

In embodiments, an intensity of the light effect increases as the speed of the at least one user increases.

In embodiments, a volume of the sound increases as the speed of the at least one user increases.

In embodiments, the audio controller is configured to control the audio emitting devices to emit the sound using Wave Field Synthesis.

According to another aspect disclosed herein, there is provided a system comprising the lighting device according to embodiments disclosed herein, and the controller according to embodiments disclosed herein.

According to another aspect disclosed herein, there is provided a lighting device according to embodiments disclosed herein, the lighting device comprising the controller embodiments disclosed herein.

According to another aspect disclosed herein, there is provided a method of controlling the lighting device of the first, the method comprising: determining at least one location on the surface of the lighting device; controlling the light emitting devices to render a light effect at the determined location on the surface; and controlling the audio emitting devices to emit a sound perceived to originate from a matching location whilst the light effect is being rendered, such that the sound is perceived to originate from the light effect.

According to another aspect disclosed herein, there is provided a computer program product for controlling the lighting device of the first aspect, the computer program product comprising code embodied on a computer-readable storage medium and configured so as when run on one or more processing units to perform operation of: determining at least one location on the surface of the lighting device; controlling the light emitting devices to render a light effect at the determined location on the surface; and controlling the audio emitting devices to emit a sound perceived to originate from a matching location whilst the light effect is being rendered, such that the sound is perceived to originate from the light effect.

### BRIEF DESCRIPTION OF THE DRAWINGS

To assist understanding of the present disclosure and to show how embodiments may be put into effect, reference is made by way of example to the accompanying drawings in which:

FIG. 1 shows the structure of a lighting device in accordance with embodiments of the present invention.

FIG. 2 is an example of wave field synthesis in a room;

FIGS. 3A and 3B show an example luminaire panel comprising light emitting devices co-located with a two-dimensional audio array in accordance with an embodiment of the present invention;

FIGS. 3C and 3D show another example luminaire panel comprising light emitting devices co-located with a one-dimensional audio array in accordance with an embodiment of the present invention.

FIG. 4A is a photograph of a luminous panel rendering light effects.

FIG. 4B shows additional examples of lighting effects rendered by a luminous panel;

FIG. 5 is a schematic block diagram of a system according to embodiments of the present invention;

FIG. 6 shows an audio-visual effect comprising a lighting effect and a co-located audio effect;

FIG. 7 illustrates a scenario in which multiple observers are present;

FIGS. 8A and 8B give an example of an audio-visual effect which dynamically responds to the location of a user.

### DETAILED DESCRIPTION OF EMBODIMENTS

A luminous panel comprises a large luminous surface and a light emitting device array (e.g. an LED array) covered by a surface which is an optically translucent and acoustically transparent surface, such as a textile diffusing layer. The invention comprises a luminous panel with an integrated loudspeaker array able to localize the rendered sounds based on the position of the local lighting patterns (and optionally the user position). That is, an array or matrix of audio speakers is integrated into the device. Light effects are enriched with audio, having the same spatial relation. The audio generation preferably makes use of the Wave Field Synthesis principle, so virtual audio sources can be defined and located with the light effects over a large range of observation angles. Preferably, to reduce sound pollution, the presence of people is detected and audio is directed towards the detected persons.

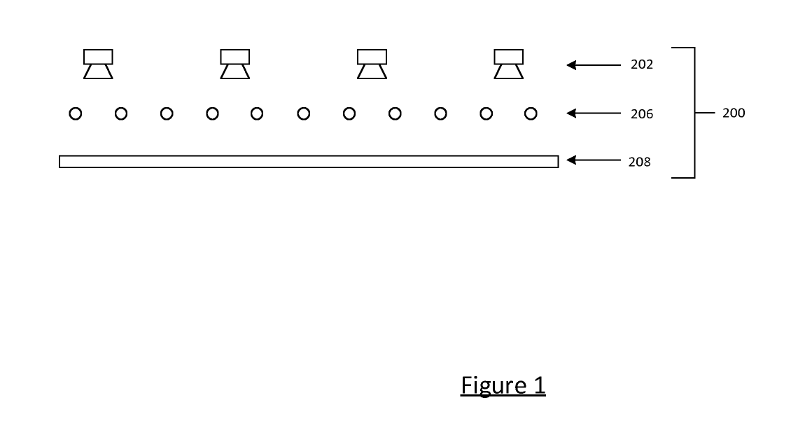

FIG. 1 shows the overall structure of a lighting device 200 according to an embodiment of the present invention, which is a luminous panel. The luminous panel 200 comprises an array of audio emitting devices 202, an array of light emitting devices 206 and an optically translucent surface 208. The array of audio emitting devices 202 and the array of light emitting devices 206 collocated with each other are placed on the same side of the optically translucent surface 208, preferably with the array of light emitting devices 206 being placed between the optically translucent surface 208 and the array of audio emitting devices 202. Therefore neither the audio or light emitting devices 202, 206 are visible from through the surface 208.

The light emitting devices 206 and the audio emitting devices 202 are located at predefined locations relative to the surface 208. Since there is a relation between the locations of the light emitting devices 206 and the audio emitting devices 202, they can be controlled such that the sounds are perceived to originate from locations matching the light effects. For example, when a light effect is created by one or more light emitting devices 206, the location of the light effect on the surface is known because of the predefined location of the one or more light emitting devices 206 relative to the surface. The audio emitting devices 202 also have a predefined location relative to the surface, so they can be controlled such that the sounds are perceived to originate from locations matching the light effects. The surface 208 has a large area, e.g. at least 1 m². For example, it may be at least 1 m×1 m along its width and height.

The surface 208 can for example be formed of a textile layer, or any other translucent (but non-transparent) surface.

The surface 208 may be a flat surface or may be curved. For example, the surface 208 may be a concave curve shape or a convex curve shape across its width or height, from the point of view of an observer.

Each audio emitting device in the array 202 may be a loudspeaker. The luminous surface 208 is acoustically transparent such that sound generated by the audio array 202 behind the surface 208 can be heard by the user 110 without any significant audible distortion. The light emitting devices 206 also do not substantially interfere with sounds generated by the audio array 202.

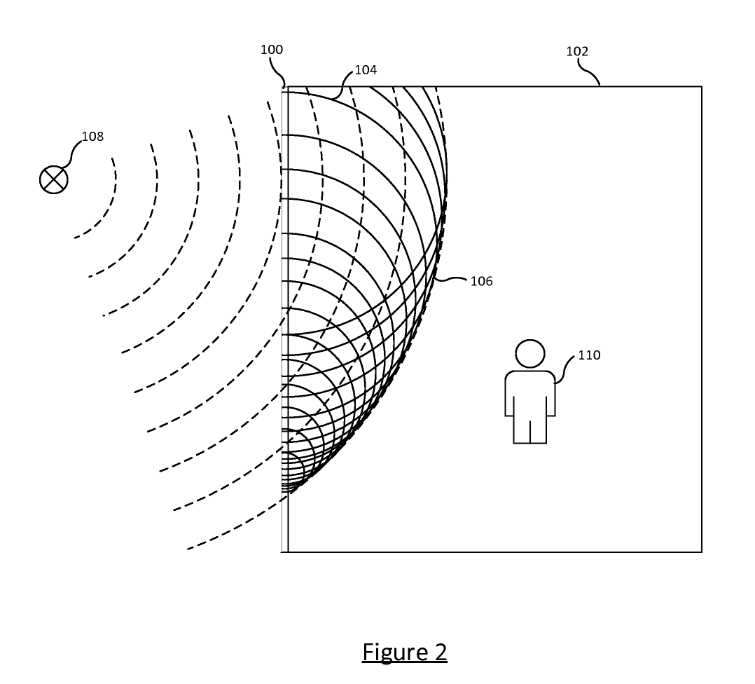

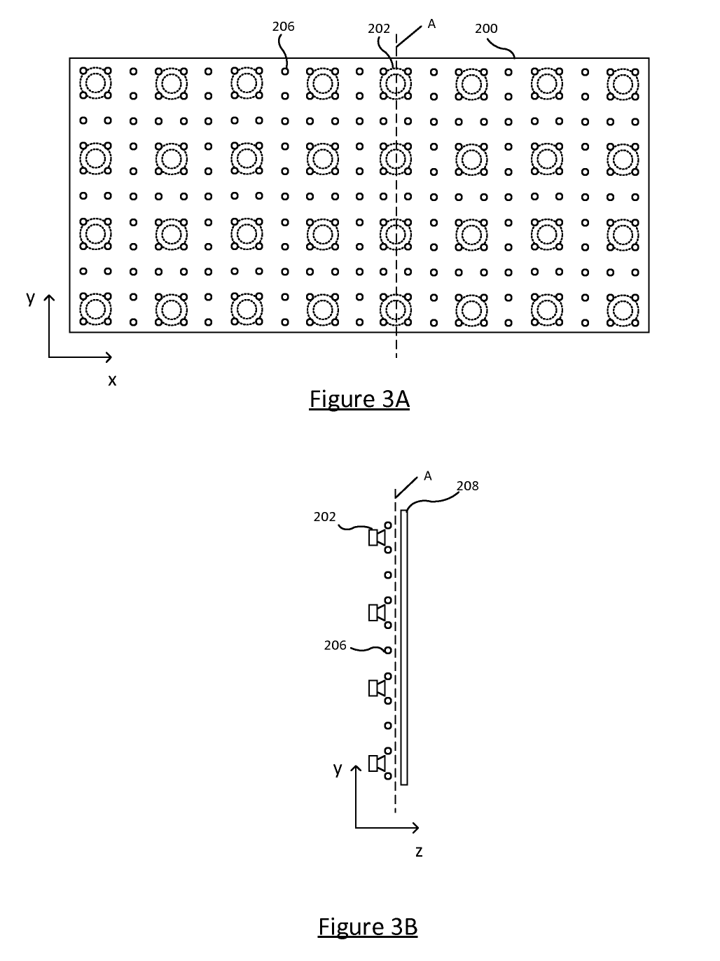

The light sources 206 are arranged in a two-dimensional array, and are capable of collectively illuminating a space (such as room 102 in FIG. 2, described later). Each comprises at least one illumination source, which can be any suitable illumination source, for example an LED, fluorescent bulb, or incandescent bulb. The plurality of light emitting devices 206 may comprise more than one type of illumination source. Each illumination source may be capable of rendering different lighting effects. In the simplest case, each illumination source is able to be in either an “on” or an “off” state. In more complex embodiments, each illumination source may be dimmable, and/or may be able to render different colours, hues, brightnesses and/or saturations. In any case, it is appreciated that the plurality of light emitting devices 206 arranged in an array such as those shown in FIGS. 3A and 3B is able to render lighting effects on the surface 208, by projecting light onto the rear of the surface that is visible through the front after scattering from the surface 208.

FIGS. 3A and 3B show front and side cross-sectional views, respectively, the lighting device 200 configured according to a first embodiment of the present invention. Line A shown in the figures indicates the line of cross-section and represents the same line in each figure. That is, FIG. 3B shows the arrangement of FIG. 3A rotated ninety degrees about line A, and vice-versa, where the cross-section is taken along line A.

In the first example, there are at least four audio devices (possibly more) arranged in a two-dimensional array.

The speakers 202 are shown by dotted lines in FIG. 3A to indicate that they are behind the light sources 206. The speaker array 202 uses audio wave field synthesis (WFS) to direct the audio from virtual audio sources to one or more observers as described in further detail below. The virtual audio sources are aligned with the rendered light effects.

The array of audio devices spans substantially all of the width and height of the array of light emitting devices, such that the audio devices at the four corners of the audio device array are collocate with the light emitting devices at the far corners of the light emitting device array.

FIGS. 3C and 3D show front and side views, respectively, of a lighting device 200 configured according to another embodiment of the present invention. Unlike the arrangement shown in FIGS. 3A and 3B, in this embodiment the plurality of speakers 202 are arranged in a one-dimensional array, or line. The array of audio devices spans substantially all the width of the array of light emitting devices, and runs horizontally across it. There are at least three audio emitting devices 202 in the array.

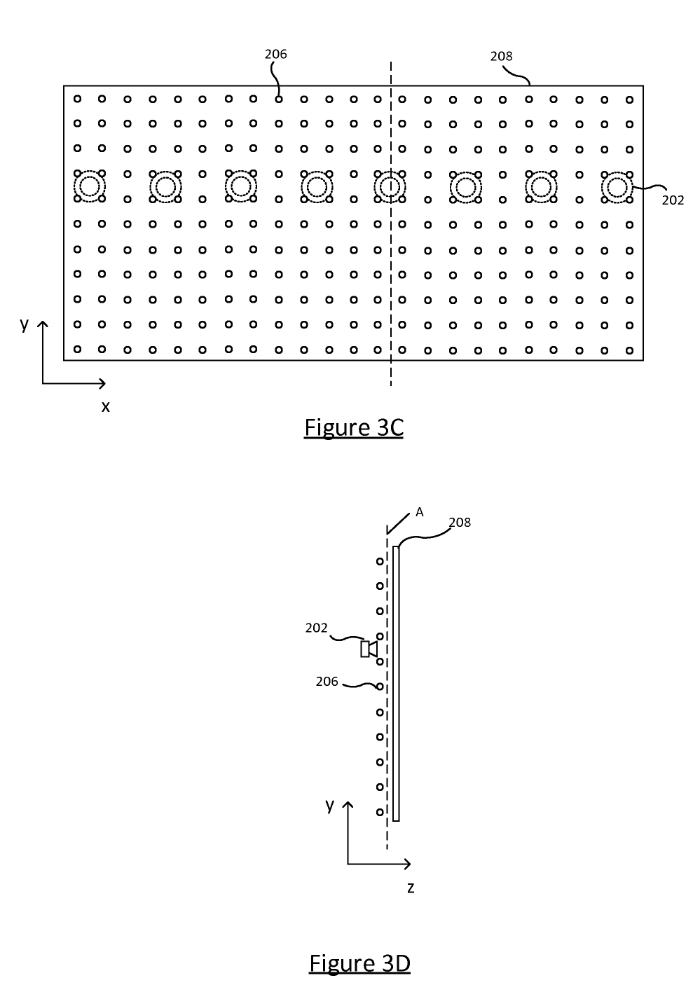

FIG. 4A shows a photograph of a real-world luminous panel. The figure shows two users 404, 406 stood in front of a luminous panel. The luminous panel is rendering light effects 402 on the surface 208. As can be seen, the light from individual light sources is scattered by the translucent surface 208 placed between them and the users. A loudspeaker array can be located behind the surface 208 in accordance with embodiments of the present invention. Neither array is visible in FIG. 4A because they are behind the surface 208.

FIG. 4B shows an example of more complex light effects rendered by the luminous panel on the surface 208. The effects include a firework effect 300, a fire effect 302, three small star effects 304a, 304b, 304c, and one large start effect 306. In the present invention, a virtual audio source is generated for each light effect by the speaker array. The distance of the virtual audio source can be very large, so the audio effect will be rather small.

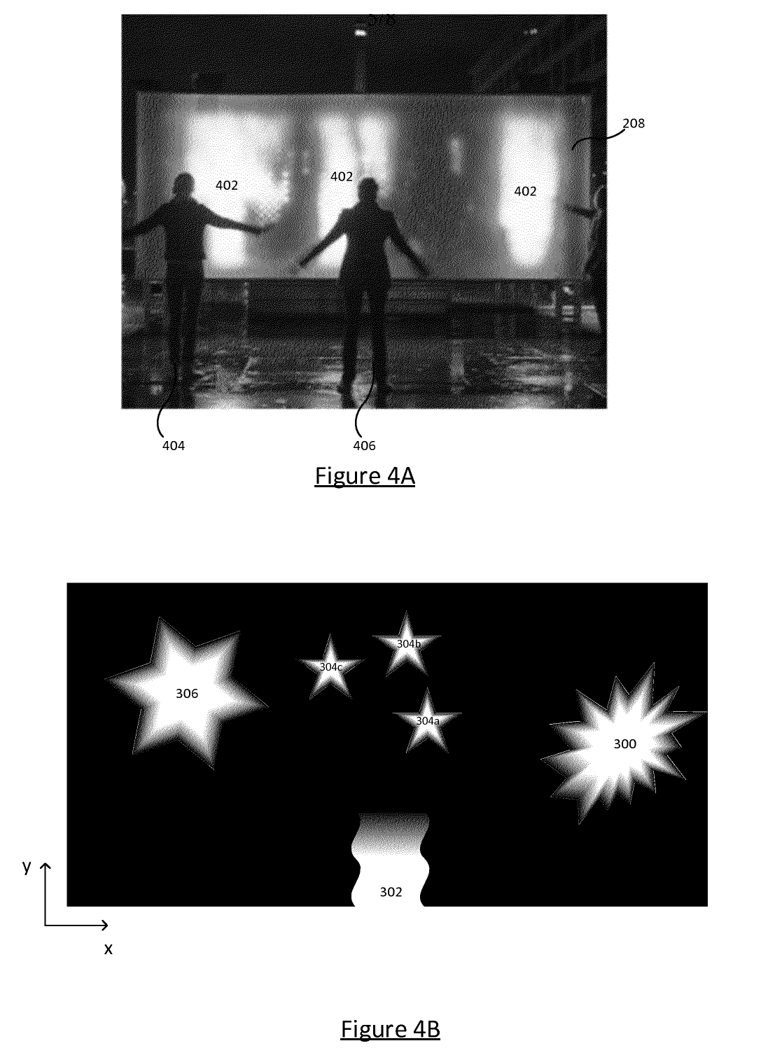

FIG. 5 shows a schematic overview of a system 500 according to embodiments of the present invention. The system 500 comprises a controller 502, an audio array 202, a luminous panel 204, and optionally a sensor 506. The audio array 202 and the luminous panel are arranged with the audio array 202 behind the luminous panel as seen by a user 110. That is, the audio array 202 and luminous panel are placed within an environment such as room 102 such that the luminous panel is arranged to create lighting effects within the room 102 which are viewable by user 110.

The controller 502 is operatively coupled to and arranged to control both the audio array 202 and the luminous panel 204. The controller 502 is shown in FIG. 5 as a separate schematic block but it is appreciated that the controller 502 may be implemented within another entity of the system such as within audio array 202 or luminous panel. Similarly, controller 502 is shown as a single entity but it is appreciated that controller 502 may be implemented in a distributed fashion as distributed code executed on one or more processors or microcontrollers. The processors or microcontrollers may be implemented in different system entities. The controller 502 comprises separate audio control module 502a and lighting control module 502b providing audio control and lighting control functionality, respectively. In this case it may be preferable to implement the audio control module in the audio array 202 and the lighting control module in the luminous panel.

As explained in detail below, the controller 400 determines a location on the surface, controls the light emitting devices 206 to render a light effect at that location (by audio controller 502a), and controls the audio emitting devices 202 to emit a sound perceived to originate from substantially that location, i.e. the same or a nearby location (e.g. slightly behind the surface).

The controller 502 can be integrated in the panel 200 itself, or it may be external to it (or part may be integrated and part may be external).

The controller 502 is connected to the audio array 202 and the luminous panel either directly by a wired or wireless connection, or indirectly via a network such as the internet. In operation, the controller 502 is arranged to control both the audio array 202 and the luminous panel via the connection. Hence it is appreciated that the controller 502 is able to control the individual audio devices and illumination sources to render lighting effects in the room 102. To do so, the controller receives or fetches data 504 relating to a lighting effect to be rendered. The data 504 may be retrieved from a memory such as a memory local to the controller 502 where the data are stored, or a memory external from the controller 502 such as a server accessible over the internet as is known in the art. Alternatively, the data 504 may be provided to the controller 502 by a user such as user 110. In this case the user 110 may use a user device (not shown) such as a smart phone to send the data 504 to the controller via a network, as is known in the art.

The system 500 optionally further comprises a sensor 506 operatively coupled to the controller 502 and arranged to detect the location of the user 110 within the environment 102. Any suitable sensor type may be used provided it is capable of determining an indication of the location of the user 110 within the environment 102. Hence, it is appreciated that while the sensor 506 is shown in FIG. 5 as a single entity, the sensor 506 may comprise multiple sensing units. For example, the sensor 506 may consist of a plurality of signalling beacons preferably placed throughout the environment 102 which communicate with a user device of the user 110 and using, for example, received signal strength indication (RSSI), trilateration, multilateration, time of flight (ToF) etc. to determine the location of the user device e.g. using network-centric, device-centric, or hybrid approaches known in the art. The determined location of the user device can then be used as an approximation of the location of the user 110. Other sensor types may not require the user 110 to have a user device. For example, passive infrared (PIR) sensors or ultrasonic sensors, or a plurality thereof. Another possibility is for the sensor 506 to be one or more cameras (which may or may not be visible wavelength cameras) to track the location of the user 110 within the environment 102. An approximate location of the user may be sufficient. Whatever sensor type used, the sensor 506 is arranged to provide an indication of the user's location to the controller 502. This location indication is used by the controller 502 in rendering audio-visual effects, as explained in more detail below.

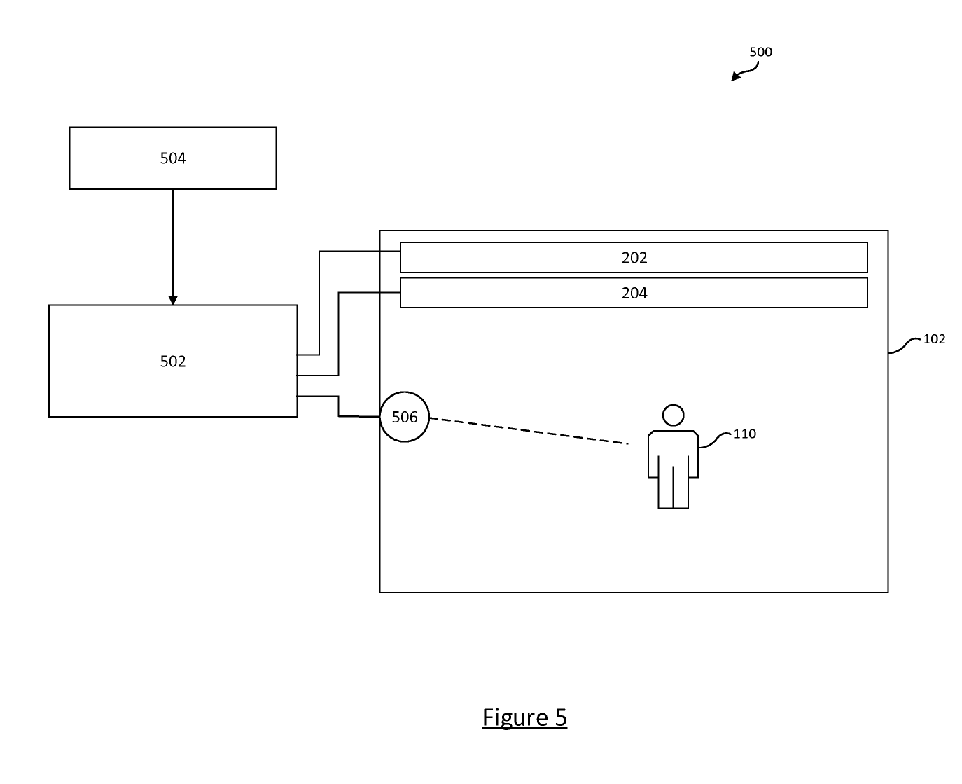

FIG. 6 shows a luminous panel and audio array 202 according to embodiments of the present invention. In FIG. 6, the luminous panel is rendering a lighting effect at lighting effect location 604, for example a fire effect such as fire effect 402 shown in FIG. 4. Simultaneously, the audio array 202 is rendering an audio effect at a virtual source location 602. Note that the virtual audio source is not confined to being located at a physical location on the luminous panel (i.e. the virtual audio source does not have to be in the same physical location as the actual rendering of the light effect). Rather, the virtual audio source can be placed behind, or indeed even in front, of the speaker array and hence also behind or in front of the luminous panel. The audio effect is preferably semantically related to the lighting effect, for example the audio effect might be a fire sound to accompany fire effect 402. The audio effect and lighting effect together may be collectively referred to as an audio-visual effect.

Audio devices such as speakers are available for rendering audio effects in a space. Known techniques such as stereo sound allow for spatialization of audio effects. That is, rendering the audio effect in a direction-dependant way. Surround sound and/or stereo speaker pair systems such as used in home entertainment systems can create an audio effect for a user in the space which is perceived to originate from a particular location. However, this effect is only properly rendered within a relatively small location, or “sweet spot”. In preferred embodiments of the present invention, the audio effects are created using Wave Field Synthesis (WFS) which allows for lighting effects rendered on a luminous panel to be accompanied by audio effects in a manner which does not confine an observer to a sweet spot in order to experience the combined audio-visual effect.

The audio controller 502 controls the array of audio sources 202 based on WFS to direct the audio from virtual audio sources to one or more users. The virtual audio sources are aligned with visual light effects rendered on the panel such that audio effects are perceived to originate from the rendered lighting effects. Preferably, the system also comprises a sensor for detecting the location of the user(s) in order to render the audio and visual lighting effects in an interactive manner.

WFS is a spatial audio rendering technique in which an “artificial” wave front is produced by a plurality of audio devices such as a one- or two-dimensional array of speakers. WFS is a known technique in producing audio signals, so only a brief explanation is given here. The basic approach can be understood by considering recording real-world audio sources (e.g. in a sound or concert) with an array of microphones. In the reproduction of the sound, an array of speakers is used to generate the same sound pattern as expected at the location of the microphone array, reproducing the location of the recorded sound sources from the perspective of a listener. However, a recording is not required, as similar effects can be synthesized.

The Huygens-Fresnel principle states that any wave front can be decomposed into a superposition of elementary spherical waves. In WFS, the plurality of audio devices each output the particular spherical wave required to generate the desired artificial wave front. The generated wave front is artificial in the sense that it appears to emanate from a virtual source location which is not (necessarily) co-located with any of the plurality of audio devices. An observer listening to the artificial wave front would hear the sound as though coming from the virtual source location. In this way, the observer is substantially unable to differentiate between the artificial wave front and an “authentic” wave front from the location as the virtual source based on sound alone.

Contrary to traditional techniques such as stereo or surround sound, the localization of virtual sources in WFS does not depend on or change with the listener's position. With a stereo speaker set, the illusion of sound coming from multiple directions can be created, but this effect can only be perceived in a rather small area between the speakers. Elsewhere, one of the speakers will dominate, especially when there is a big difference in distances between the speakers and the observer.

FIG. 2 illustrates the principles of WFS. The array of audio emitting devices 206 is disposed in a room 102. The audio devices 206 are not shown individually in FIG. 2 but the array is shown as a single element 100. Each speaker in the array 100 outputs a respective spherical wave front (see for example wave front 104) which combine to produce a synthesized wave front 106. The plurality of spherical wave fronts is such that the combined wave front 106 appears to originate from a virtual source 108 in that it approximates the “real” wave front which would have arisen had a real-world audio source been physically placed at the location of the virtual source 108.

The spherical wave fronts can be determined by capturing a (real-world) sound with an array of microphones, or by purely computational methods known in the art. In any case, an observer 110 experiences the sound as though originating from the location of the virtual source 108.

Note that the example in FIG. 2 is shown only in two dimensions, but the principles of WFS extend to three dimensions when applied to the two-dimensional array of FIG. 3A. That is, WFS can be applied both to the one-dimensional audio array of FIG. 2A and the two-dimensional audio array of FIG. 2C.

Using WFS, it is generally possible to locate the virtual audio source 108 at a desired location not only in the plane of the surface 208 (x,y) plane, but also at different depths relative to the surface 208 (z-direction). Although light effects are rendered on the screen 208, their virtual location might be behind the screen (e.g. fireworks). In these cases it is desirable to locate the virtual audio source as having some distance behind the screen. However, in practice it may be sufficient to just locate the virtual audio source 108 on the surface 208 (z=0).

As can be seen in FIG. 6, the audio effect and the lighting effect are spatially correlated insofar as they both appear to be originating from the same point on the surface 208. Note that this correlation is observed by users from any location within the room. For example, a user at location 610 observes the audio effect and lighting effect as coming from the same direction, as does a user at location 612.

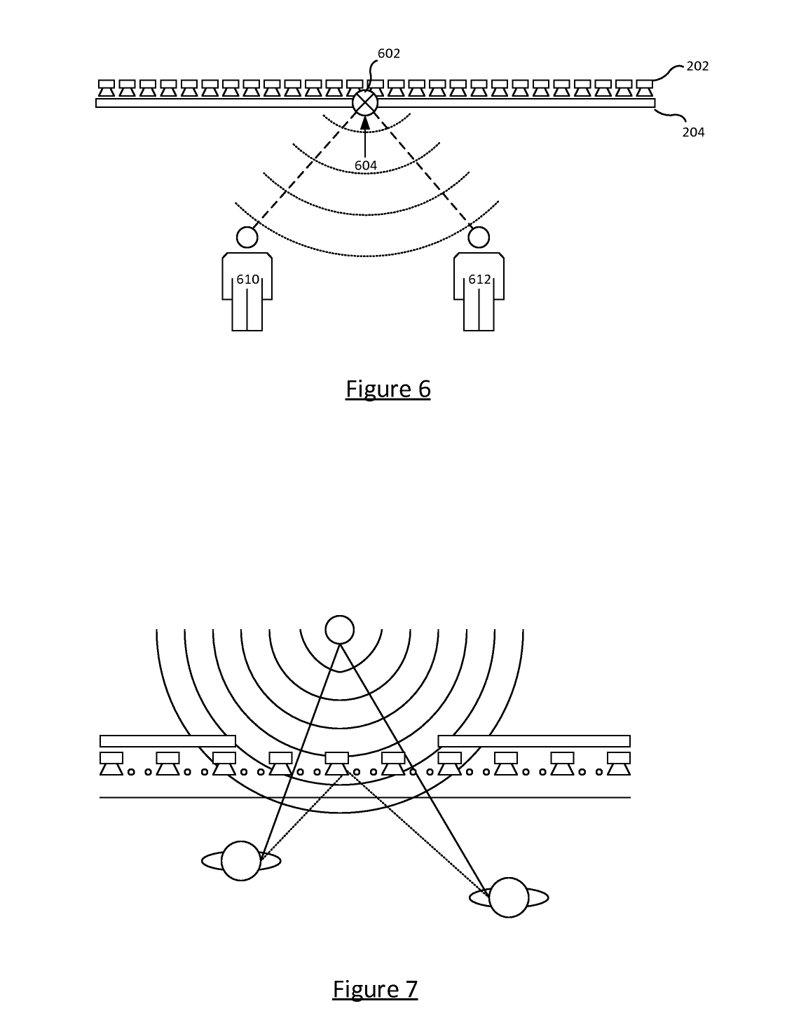

In the situation shown in FIG. 7, two observers are in front of the panel. The light part generates a fire effect at ground level, in between the observers. The position of the observers is tracked and the location of this fire can depend on the location of the observers. A virtual audio source is created at the location of the fire effect.

The audio effect coming from a few speakers is too distributed, so also the sound might cause an audio pollution in the environment. To reduce pollution, the presence of people is tracked and virtual audio absorbers are placed between the virtual audio source and the empty areas in front of the panel. The virtual acoustic sources are used in the WFS. A virtual acoustic absorber is derived from this and indicates where sound effects should be actively cancelled. The controller 502 implements the WFS by calculating the wave field at the location of each speaker in the audio array 202 and deriving the signal for individual speakers to generate such a field.

The concept of virtual audio absorbers is derived from virtual audio sources and wave field synthesis. When implementing WFS by recording a (real) sound source using an array of microphones, real absorbers are placed in between the microphones and sources. The recorded audio is thus damped for some microphones behind the absorbers. When going to sound synthesis (WFS output by the audio array), the speakers that correspond to microphones which were behind the virtual absorbers at the recording stage, should also actively damp/mute the sound (like in noise cancellation). Hence, with virtual audio absorbers some speakers are actively reducing the sound to locations where no people are present.

It is also the intention to have some depth in the virtual sources. Although the light effect rendering is on the screen, the virtual source might be behind, as e.g. with fireworks. The use of virtual audio absorbers is in this case particularly useful when rendering sounds. This is because a virtual audio source which is aligned with a virtual light effect source (i.e. where the light effect is perceived to originate from) may be behind the translucent surface and hence not entirely aligned with the rendering location of the light effect itself. This may mean that two observers within the environment perceive a mismatch between the perceived location of the audio and light effect. It is clear that the observers will see some light effect in between them and on the screen while the audio seems further away

To compensate for this, when an effect is rendered for two observers, the confusion is minimized by directing the audio to a narrower location using virtual audio absorbers, having larger light effects, and having distant effects like fireworks (even with a delay between light and sound), or a combination thereof.

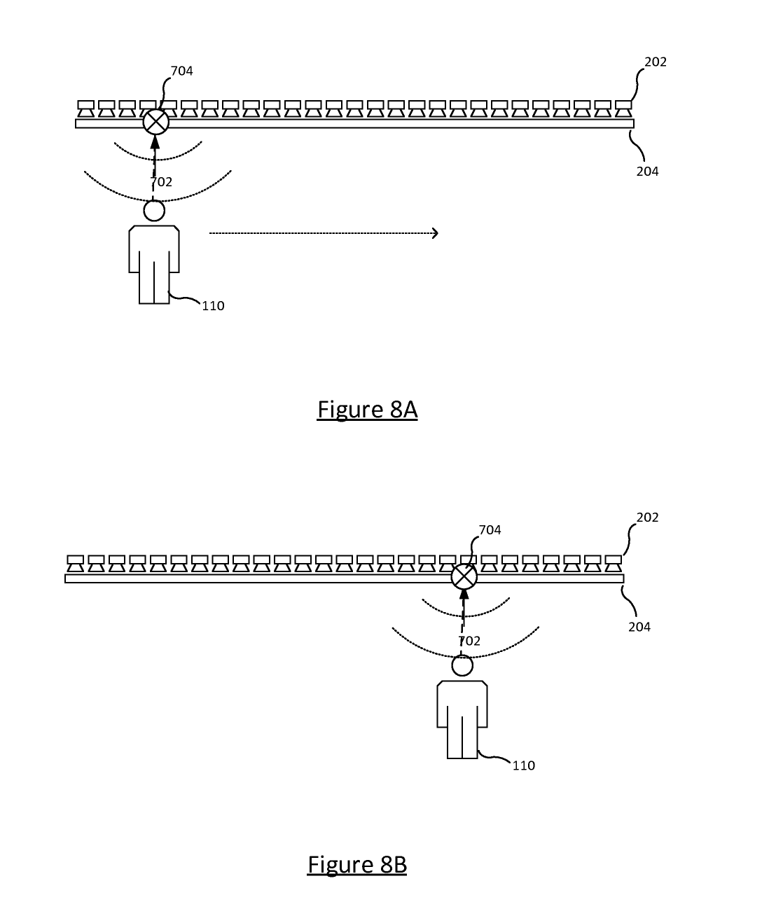

FIGS. 8A and 8B show an embodiment in which an audio-visual effect dynamically responds to the location of the user 110. The audio-visual effect comprises a lighting effect component 702 and a co-located audio effect component 704. In FIG. 8A, the controller 502 is controlling the luminous panel and audio array 202 to render the audio-visual effect directly in front of the user 110, i.e. at the closest point to the user 110 on the surface but it is appreciated that the audio-visual effect may be rendered at any other point on the surface relative to the user 110. The user's position is measured by the sensor 506 and provided to the controller 502 in determining the respective locations for the lighting effect 702 and the virtual source location of the audio effect 704.

Readings from the sensor 506, as provided to the controller 502, can also be used by the controller 502 in a dynamic way. That is, the controller 502 is able to update the location of the audio-visual effect in response to a changing user location. For example, if the user 110 moves as shown by the arrow in FIG. 8A to the location shown in FIG. 8B, the controller 502 is able to track the user's location using data from the sensor 506 in order to dynamically render the audio-visual effect to follow the user 110 as he moves within the environment. As can be seen from FIGS. 8A and 8B, the audio-visual effect is able to maintain a constant heading relative to the user 110 as he moves. It is further appreciated that location data from the sensor 506 may also be used by the controller 502 to create other dynamic effects such as moving the audio-visual effect in the opposite direction to the user's motion.

However, as shown in FIGS. 8A and 8B, when the user 110 is moving in front of the screen, the lighting effect and associated virtual audio source are moving together with the detected user 110. This effect is advantageous, for example, in a public setting where it may be used to inform people that they have been observed (detected by the system) and trigger them either implicitly or explicitly via a visual or audio indication through the luminous panel or audio array to go into interaction with the audio-visual effect.

Location data of the user 110 may be used by the controller 502 to create move complex interactions. For example, the controller 502 may be able to determine the speed of the user's motion from time stamps of the sensor readings, as known in the art. In this case the controller 502 may create audio-visual effects in which one or both of the visual or audio components depend on the speed of the user. For example, a fast movement of the user 110 may result in a fire audio effect which is louder, or a fire visual effect which is brighter or larger on the panel.

It will be appreciated that the above embodiments have been described only by way of example. Other variations to the disclosed embodiments can be understood and effected by those skilled in the art in practicing the claimed invention, from a study of the drawings, the disclosure, and the appended claims.

For instance, simply co-locating the local audio effect with a local light effect without any advanced direction audio rendering or user position detection.

As another example, in an alternate and somewhat simpler embodiment as an alternative to WFS, the luminous panel may have a large number of light sources 206 similar to embodiments described above, but only a limited number of loudspeakers in a number of segments. The speaker array 202 could be segmented based on the number and position of the loudspeakers, (e.g. 4 or 9 loudspeakers arranged in a square). The luminous panel has means to keep track of the approximate position (segment) of each local light effect being rendered, including the sound effects associated with it. It then renders those sounds on the loudspeakers which correspond with the segment(s) where the local light effect is present. That is, the controller 502 determines which segment the lighting effect is currently being rendered in and controls the speakers in that segment to render the audio effect. Optionally, the audio rendering is done on multiple loudspeakers whereby the volume depends on the contribution of the local light effect in the corresponding loudspeaker segment.

In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored and/or distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A system comprising:
a lighting device comprising:
a plurality of light emitting devices arranged in a two-dimensional array;
a plurality of audio emitting devices; and
an optically translucent surface located forward of both the light emitting devices and the audio emitting devices such that the devices are not directly visible through the surface, wherein the surface is acoustically transparent such that sounds emitted from the audio emitting devices are audible through the surface, wherein the light emitting devices and the audio emitting devices are located at predefined locations relative to the surface; and
a controller for controlling the lighting device, the controller comprising:
a location determining module configured to determine at least one location on the surface of the lighting device;
a light controller configured to control the light emitting devices to render a light effect at the determined location on the surface;
an audio controller configured to control the audio emitting devices to emit a sound perceived to originate from the determined location whilst the light effect is being rendered; and
a sensor input configured to connect to at least one sensor, wherein the location on the surface is determined based on a location of at least one user detected by the at least one sensor.

2. The system according to claim 1, wherein the plurality of audio emitting devices is at least three audio devices.

3. The system according to claim 2, wherein the at least three audio emitting devices are arranged in a one-dimensional array.

4. The system according to claim 2, wherein the plurality of audio emitting devices is at least four audio emitting devices arranged in a two-dimensional array.

5. The system according to claim 1, wherein the audio devices are arranged for emitting sounds from matching locations using Wave Field Synthesis.

6. The system according to claim 1, wherein the optically translucent surface is a curved optically translucent surface.

7. (canceled)

8. The system according to claim 1, wherein the location determining module is configured to change the location on the surface such that the sound is perceived to originate from a moving light effect.

9. The system according to claim 1, wherein at least one characteristic of the light effect and/or the sound is varied based on a detected speed of the at least one user.

10. The system according to claim 1, wherein the audio controller is configured to control the audio emitting devices to emit the sound using Wave Field Synthesis.

11. A method of controlling a lighting device, the lighting device comprising: a plurality of light emitting devices arranged in a two-dimensional array; a plurality of audio emitting devices co-located with the light emitting devices; and an optically translucent surface located forward of both the light emitting devices and the audio emitting devices such that the devices are not directly visible through the surface, wherein the surface is acoustically transparent such that sounds emitted from the audio emitting devices are audible through the surface, wherein the light emitting devices and the audio emitting devices are located at predefined locations relative to the surface, the method comprising:
determining at least one location on the surface of the lighting device;
controlling the light emitting devices to render a light effect at the determined location on the surface; and
controlling the audio emitting devices to emit a sound perceived to originate from the determined location whilst the light effect is being rendered, such that the sound is perceived to originate from the light effect,
wherein the location on the surface is determined based on a location of at least one user detected by the at least one sensor.

12. A computer program product for controlling a lighting device, the lighting device comprising: a plurality of light emitting devices arranged in a two-dimensional array; a plurality of audio emitting devices co-located with the light emitting devices; and an optically translucent surface located forward of both the light emitting devices and the audio emitting devices such that the devices are not directly visible through the surface, wherein the surface is acoustically transparent such that sounds emitted from the audio emitting devices are audible through the surface, wherein the light emitting devices and the audio emitting devices are located at predefined locations relative to the surface; the computer program product comprising code embodied on a computer-readable storage medium and configured so as when run on one or more processing units to perform operation of:
determining at least one location on the surface of the lighting device;
controlling the light emitting devices to render a light effect at the determined location on the surface; and
controlling the audio emitting devices to emit a sound perceived to originate from the determined location whilst the light effect is being rendered, such that the sound is perceived to originate from the light effect,
wherein the location on the surface is determined based on a location of at least one user detected by the at least one sensor.
